(19) United States
(12) Patent Application Publication
(10) Pub. No.: US 2005/0233193 A1
(43) Pub. Date: Oct. 20, 2005

(54) Fuel cell stack comprising a counterflowing cooling system and a plurality of coolant-collecting ducts located parallel to the axis of the stack

(76) Inventors: Stefan Holler, Lubeck (DE); Uwe Kuter, Lubeck (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/520,472

(22) PCT Filed: Jun. 28, 2003
(86) PCT No.: PCT/DE03/02154

§ 371 Date: Apr. 7, 2005

(30) Foreign Application Priority Data
Jul. 12, 2002 (EP) 02015490.2

(51) Int. Cl. H01M 8/04; H01M 8/10; H01M 2/08; H01M 8/02

(52) U.S. Cl. 429/26; 429/32; 429/38; 429/35

(57) ABSTRACT

A fuel cell stack comprising several superimposed polymer electrolyte membrane fuel cells. A bipolar plate that is provided with longitudinal ducts supplying hydrogen and transverse ducts which supply oxygen and are used for cooling is arranged between adjacent membrane-electrode units. A current flowing in opposite directions through adjacent ducts of the same fuel cell can be created within the air ducts via collecting ducts that are provided at the outflow end for every other cooling duct if the flow is fed to the stack from both sides, resulting in a very homogeneous temperature distribution with the cell or stack.

### FIELD OF THE INVENTION

The invention relates to a fuel cell stack according to the features specified in the introductory part of claim 1.

### BACKGROUND OF THE INVENTION

Such fuel cell stacks are constructed of fuel cells of the polymer-electrolyte-membrane construction type and consist of several cells arranged into a stack. The basic construction of such cells is known per se, and in this context DE 195 44 323 A1 and DE 199 38 589 A1 are referred to.

Fuel cell stacks constructed of such fuel cells are likewise counted as belonging to the state of the art. A fluid-cooled fuel cell stock with 5.5 kW power is offered on the part of Proton Motor GmbH under the part description HZ40. With this stock, the supply of fuel on the one hand and the supply of oxygen in the form of air supply on the other hand are effected via central connections, and the distribution within the stack is effected via channel systems. In order to lead away heat which arises during operation, a fluid cooling is provided which likewise functions via central connections and a channel system led within the bipolar plates.

A problem with such fuel cell stacks is often the removal of the reaction heat arising on account of the catalytic process, which is either to be led away via the supplied air oxygen or however via a separate, for example also fluid-leading cooling system. On the one hand a fuel cell on operation should have a temperature which is as high as possible in order to operate with a good efficiency, but on the other hand the temperature must not be so large that the water stored in the polymer electrolyte membrane evaporates, since the proton conductivity of the membrane reduces with a falling water content. Therefore an operating temperature for example of 60° C. to 90° C. is desirable, depending on the applied membrane. This temperature should be as constant as possible over the surface of a fuel cell as well as within the stack so that where possible all fuel cells operate with a high efficiency over their complete surface.

In particular with fuel cell stacks of a small or middle power, a further problem may occur if, due to unfavorable channel cross sections and channel lengths, one must provide a relatively high pressure in order to lead the coolant through the channel system. The power of auxiliary units required for this regularly reduces the efficiency.

### BREIF SUMMARY OF THE INVENTION

Against this background it is the object of the present invention to design a fuel cell stack of the initially mentioned type such that an as uniform as possible temperature distribution within the individual fuel cells and within the fuel cell stack is given, with an as low as possible flow resistance.

According to the invention, the features specified in claim 1 achieve this object. Advantageous formations of the invention are specified in the dependent claims, the subsequent description as well as the drawings.

The basic concept of the present invention to lead the cooling fluid within each fuel cell of the fuel cell stack such that the through-flow direction of adjacent channels of the same fuel cell is opposite to one another. Since the channels are open at both sides, the inflow is always effected in a parallel manner, which means that the channels are not flowed through in series successively. A very uniform temperature distribution within the fuel cell and thus also within the fuel cell stack is achieved by way of this, wherein the flow resistance, in particular with a suitable connection of the channels as will be described in the following, is comparatively low.

The design of the routing of the channels within a fuel cell for air oxygen in a serpentine or meandering manner is counted as belonging to the state of the art. With such a design, the through-flow direction of adjacent channels, although likewise being in opposite directions, with this however the channels do not lie parallel in the inflow direction but connected successively, which thermally as well as fluidically is somewhat unfavorable since on the one hand the removal of heat close to the end at the outflow side as a rule is inadequate and on the other hand a considerable pressure is to be mustered for the through-flow which likewise worsens the efficiency.

The parallel inflow (through-flow) of the channels which are arranged parallel to one another and are open at both sides, in a manner such that the through-flow direction of adjacent fuel channels of the same fuel cells is opposite to one another, in contrast permits a good cooling with a low flow resistance, which leads to a more uniform heat distribution within the fuel cell and thus also of the fuel cell stack.

In order not to have to individually route the channels of the individual fuel cells, but to be able to connect them with little expense with regard to manufacturing technology, it is useful to connect the inflow and outflow sides of channels lying above one another, of the fuel cells arranged into a stack, in a common collector channel which preferably runs parallel to the axis of the stack in order thus to create a short and thus low-resistance conduit connection.

It is particularly favorable if several collector channels are arranged parallel to one another and on both sides of the stack so that preferably all channels at the inflow side or outflow run into a collector channel. One may realize the inventive flow arrangement in a manner which is simple with regard to design and which is fluidically favorable by way of such collector channels arranged at the end face at the end of the fuel cells or of the fuel cell stack.

The channels may exclusively or not exclusively serve for the cooling, depending on the energy density in the fuel cell stack. If the channels exclusively serve as cooling channels, then a fluid which is independent of the remaining function, thus a gas or liquid may be led through the channels. The quantity of heat which may be removed is comparatively high, particularly with the use of a liquid.

A design with which the cooling channels simultaneously serve for the supply of oxygen to the fuel cells, and are designed as channels which are open towards the cathode of the respective membrane electrode assembly is particularly favorable. Such an arrangement is particularly favorable since then a much less complicated oxygen supply may be effected by way of the supply of surrounding air which where appropriate may be purified. With such an arrangement one also simultaneously achieves an improved oxygen supply of the fuel cell stock with an increasing removal of heat, which is advantageous. Moreover then the required energy expense for the energy which is consumed for the through-flow for the purpose of cooling is usually lower than with a separate network of cooling channels.

In the same manner, the channel routing on the anode side may be also designed for the supply of fuel, i.e. then, by way of the fuel, one may achieve an additional cooling of the respective cell on the anode side too. Where appropriate, as initially described, one may also provide a separate cooling channel system additionally to an anode-side and/or cathode-side cooling. The inventive channel routing for fuel-leading or oxygen-leading channels, apart from a uniform temperature distribution within the fuel cell or the cell stack furthermore has the significant advantage that the reactands are introduced distributed over the surface of the cell in a particularly uniform manner, which leads to a uniform charging and thus also burdening of the cell.

The cooling channels preferably have a clear width of less than 3 mm, preferably of about 2 mm. Such an arrangement is particularly advantageous if the cooling channels also serve for the supply of the stack with air oxygen, since then the abutment contact surfaces of the carbon layer in which these channels open towards the cathode are usually provided, are designed such that an adequate pressing pressure on the proton exchange membrane is given, so that the membrane is effective over as much of its surface as possible. On the other hand the above-mentioned dimensioning ensures that the through-flow of the channels is ensured with comparatively small flow losses, i.e. with the provision of only a small excess pressure. At the same time the cooling channels should usefully have a length between 20 mm and 200 mm. It is to be understood that the clear width of the channels may be smaller, the shorter are the channels and vice versa.

The collector channels by way of which the cooling channels may be supplied at the inflow and outflow side, may be designed in a simple manner by way of providing suitable recesses in the fuel cell stock at the edges. These recesses are thus provided in all the layers of the fuel cells which cover this edge region, and thus of the fuel cell stack, preferably in the inactive edge region, so that collector channels are formed arranged parallel to the axis of the stack after assembly of the stock.

If, as is counted as belonging to the state of the art, the bipolar plates of the fuel cells are incorporated in an elastic edge which simultaneously forms the lateral sealing of the respective fuel cell to the outside, then the collector channels may be formed by recesses in the sealing edges lying above one another. With regard to design, therefore with the exception of the recesses, no special provisions need to be made for creating these collector channels.

Preferably the coolant is supplied with an excess pressure of 0.1 to 10 bar or is led away with a corresponding vacuum. Such a pressure may be produced by blowers, as they are applied for example in semiconductor technology, e.g. CPU blowers which require little supply energy. Radial filters which function in a comparatively energy-efficient manner may even produce the above-mentioned pressure range.

### DESCRIPTION OF THE DRAWINGS

The invention is described in more detail by way of one embodiment example represented in the drawings. There are shown in:

FIG. 1 in a greatly schematized representation, a fuel cell stock according to the invention, with collector channels at the outflow side and in a greatly schematized representation, a section through the cooling channel system of a fuel cell transverse to the axis of the fuel cell stack according to FIG. 1, along the section line II-II in FIG. 1

### DETAILED DESCRIPTION OF THE INVENTION

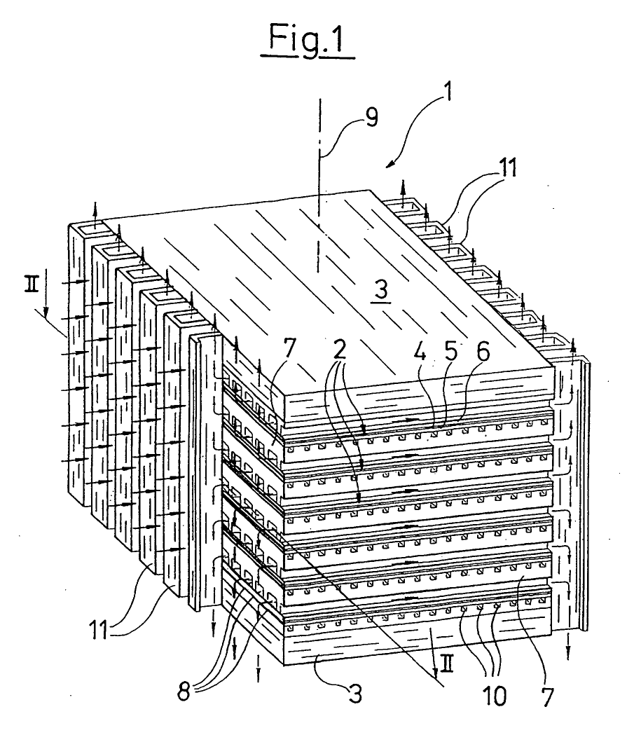

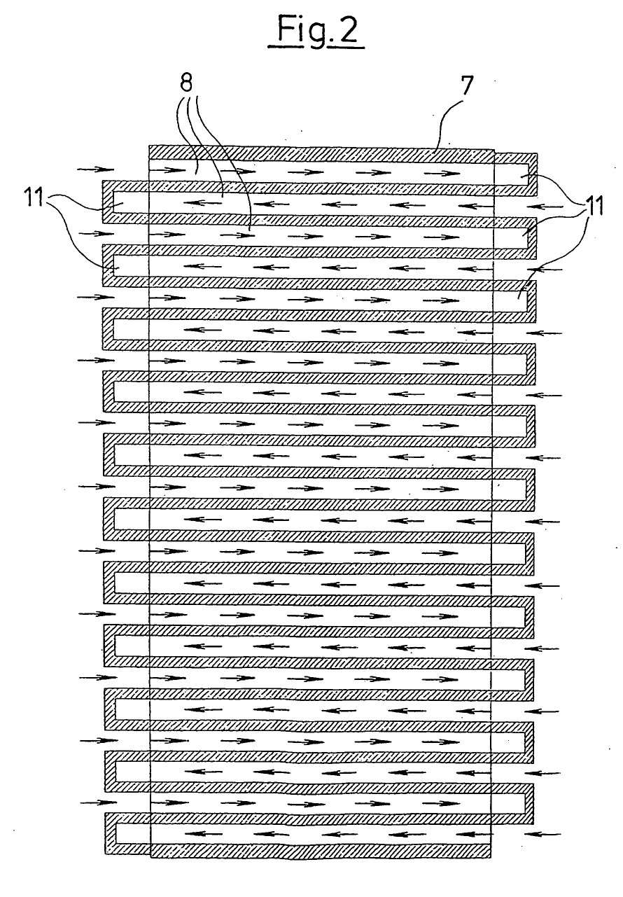

The fuel cell stack 1 schematically shown in FIG. 1 is constructed in a manner known per se, of a multitude, here six fuel cells 2 which are arranged above one another and are clamped between end plates 3. Each fuel cell 2 consists of a membrane electrode assembly which is formed by c film 4 in the form of a polymer electrolyte membrane, an anode 5 lying thereon as well as a cathode 6 lying on the other side. A bipolar plate 7 is arranged between adjacent membrane electrode assemblies 4, 5, 6, which is electrically conductive and is formed essentially of carbon.

Each bipolar plate 7 on its side facing the cathode 6 comprises transverse channels 8 which are open towards both ends, are arranged parallel to one another and extend transversely to the stack axis 9 as well as to the longitudinal channels 10 which are likewise provided within the bipolar plate 7 and are open towards the anode 5. The longitudinal channels 10 serve for the supply of fuel, in particular hydrogen, to the cells. They are formed by grooves on the upper side of each bipolar plate 7, said grooves being one towards the anode and rectangular in cross section. The transverse channels 8 in contrast serve the supply of oxygen to the fuel cells 2 as well as for the removal of heat, thus for cooling. The supply of oxygen as well as the cooling is effected by way of an airflow which is produced by way of a blower and which, with the fuel cell stack 1 represented in FIG. 1, is present on the left side as well as the right side of the stack by way of a suitable channel routing (not shown).

Since the routing of the air (arrows), as described initially, within a fuel cell 2 is designed such that the flow runs in opposite directions in adjacent transverse channels 8 of each fuel cell 2, the outlets of the transverse channels 8 of the fuel cells 2 arranged above one another are connected to one another in a conducting manner by way of collector channels 11 arranged parallel to the stack axis 9, as is evident from FIG. 1. The collector channels 11 which in FIG. 1 are represented by components which are U-shaped in cross section, may be designed in various manners, as has been explained initially. They are designed and arranged such that they connect the outflow sides of the ends of the transverse channels 8 of all fuel cells 2 in a conducting manner, said ends lying above one another in the axial direction 9, but do not affect the inflow sides in each case of channels 8 adjacent to the right and left. The components therefore are designed and arranged such that with an inflow of air of the fuel cell stack from the left and right side seeing in the Figure, in each fuel cell 2 in the transverse channels 8, a flow sets in as is represented by way of example in FIG. 2 by way of the cross section through the air channels 8 of a fuel cell 2 (by way of arrow representation).

With the shown embodiment example, the channel connection by way of the collector channels 11 is effected in each case on the outflow side. It may however also be effected at the inflow side which would means a reversal of all flow directions in the figures.

The collector channels represented schematically in FIGS. 1 and 2 as a rule are formed on construction of the fuel cell stack 1 in that suitable recesses are formed in the edge region of the components for example 4, 5, 6, 7 or their enclosure at the edge. The collector channels 11 at the some time are to be designed such that an as low as possible flow resistance results.

In order to keep down the flow resistance also within the fuel cells, in particular for the supply of air, the transverse channels 8 are suitably dimensioned with regard to cross section and length. In the present embodiment example, the transverse channels 8 have a clear width of 2 mm with a length of 100 mm. In this manner one may ensure a good through-flow of the fuel cell stack 1 even with only a slight excess pressure. In the present example, with a suitable channel routing to the end-faces of the fuel cell stack 1, a small radial blower or CPU blower is sufficient in order to adequately supply the fuel cell stock 1 with oxygen as well as with cooling air.

The above-described arrangement as a rule ensures a very uniform temperature distribution within the fuel cell stack 1. If the cooling of such an arrangement is not sufficient or a separate cooling system is to be arranged for other reasons, then this may be effected by way of a suitable arrangement of cooling channels, for example in the bipolar plate 7 between the transverse channels 8 and the longitudinal channels 10 with a suitable channel routing via collector channels 11. It is to be understood that in this case the conducting connection for the channels 8 leading the oxygen needs to be provided separately for the channels 10 leading the fuel.

1-11. (canceled)

12. A fuel cell stack, comprising:
a plurality of fuel cells arranged in a stack, each of said fuel cells being of polymer electrolyte membrane construction and comprising a membrane electrode assembly,
each of the fuel cells defining a plurality of essentially parallel channels for conducting cooling fluid between adjacent membrane electrode assemblies, each of said channels having two open ends, wherein a direction of flow of one of said channels is opposite to the direction of flow of adjacent ones of said channels in said each of said fuel cells.

13. The fuel cell stack of claim 12, wherein each of said channels has an inflow side and an outflow side, said fuel cell stack further comprising a common collector channel, wherein one of inflow sides and outflow sides of said channels that are arranged one above the other are connected in said common conductor channel.

14. The fuel cell stack of claim 13, further comprising a plurality of common collector channels arranged in parallel on two sides of said fuel cell such that each of the one of inflow sides and outflow sides of said channels run into one of said plural common collector channels.

15. The fuel cell stack of claim 12, wherein said plural channels are arranged exclusively for cooling said fuel cells, said plural channels conducting one of a gas and a fluid.

16. The fuel cell stack of claim 12, wherein each of said membrane electrode assemblies comprises an anode electrode and a cathode electrode, wherein said channels are open toward said cathode electrode and conduct an oxygen supply toward said cathode electrodes.

17. The fuel cell stack of claim 12, wherein each of said membrane electrode assemblies comprises an anode electrode and a cathode electrode, wherein said channels are open toward said anode electrode and conduct a fuel supply toward said anode electrodes.

18. The fuel cell stack of claim 12, wherein said channels have a width of less than 3 mm.

19. The fuel cell stack of claim 18, wherein said channels have a length in the range 20 mm to 200 mm.

20. The fuel cell stack of claim 13, wherein said stack comprises a recess at an end thereof forming said common collector channel.

21. The fuel cell stack of claim 13, further comprising an elastic sealing edge surrounding a bipolar plate of said each of said fuel cells and arranged between adjacent fuel cells, said common collector channel being formed by recesses in said sealing edges lying above one another.

22. The fuel cell stack of claim 12, wherein said channels are arranged such that an adequate supply of coolant is supplied with an excess pressure of 0.1 to 10 bar.

23. The fuel cell stack of claim 13, wherein said stack comprises an axis through a center of each fuel cell and said common collector channel runs parallel to said axis of said stack.

24. The fuel cell stack of claim 18, wherein said channels have a width approximately 2 mm.

25. The fuel stack of claim 12, wherein said channels have a length in the range 20 mm to 200 mm.

26. The fuel stack of claim 12, wherein said channels are arranged such that an adequate supply of coolant is drawn by a vacuum or negative pressure of 0.1 to 10 bar.

27. The fuel cell stack of claim 12, wherein said common collector channel is formed by an enclosure along an edge of said each one of said fuel cells.
